(19) United States
(12) Patent Application Publication
(10) Pub. No.: US 2014/0030536 A1
(43) Pub. Date: Jan. 30, 2014

(54) Biodegradable Coextruded Multilayer Films

(71) Applicant: Rajendra K. Krishnaswamy, Lexington, MA (US)

(72) Inventor: Rajendra K. Krishnaswamy, Lexington, MA (US)

(73) Assignee: METABOLIX, INC., Cambridge, MA (US)

(21) Appl. No.: 14/111,170

(22) PCT Filed: Apr. 11, 2012
(86) PCT No.: PCT/US2012/033040

§ 371 Date: Oct. 10, 2013

Related U.S. Application Data
(60) Provisional application No. 61/475,200, filed on Apr. 13, 2011.

(51) Int. Cl. B32B 27/08; B32B 37/18; B32B 7/12

(52) U.S. Cl. CPC B32B 27/08; B32B 7/12; B32B 37/182
USPC 428/483; 428/480; 156/244.11

(57) ABSTRACT

Described herein is a biobased, fully biodegradable multilayer film having gas barrier properties. Also included is a method of making such material.

### RELATED APPLICATION

This application claims the benefit of U.S. Provisional Application No. 61/475,200, filed on Apr. 13, 2011, the entire teachings of which are incorporated herein by reference.

### BACKGROUND OF THE INVENTION

Multilayer polymer films are used in a wide variety of consumer product applications. Perhaps the most visible consumer applications for multilayer polymer films are in the packaging used for food. Food packaging represents a multibillion dollar industry in the US, Europe and Asia ($13.5 billion) with a projected annual growth rate of 4.3%. It is anticipated that the consumption of snack foods such as chocolates, nuts, and potato chips will fuel the increased demand for food packaging materials in the future. The performance requirements for food packaging materials can be divided into five areas: containment, protection, communication, functionality, environmental and safety issues. In terms of material properties, the packaging must be flexible, sealable and function as a good barrier to both moisture and oxygen in order to protect the integrity of the food. Most of the food packaging materials that meet these requirements are derived from petroleum-based feedstocks. Polymers such as polyethylene terephthalate, oriented polypropylene, and ethylene-propylene copolymers are commonly combined into multilayer films for food packaging applications. The problem with all of these materials is that they are not biodegradable nor are made from renewable feedstocks. Given the amount of food packaging materials that are used each year, there is a need to develop new biobased, biodegradable materials that meet or exceed the performance requirements for food packaging applications.

### SUMMARY OF THE INVENTION

Described herein are multilayer, fully biodegradable films comprised of polyhydroxyalkanoate (PHA) outer layers, a polyvinyl resin core and ethylene vinyl acetate copolymer adhesive layers between the outer layers and core. FIG. 1 shows a schematic diagram of a cross section of the multilayer film.

In one aspect, one or more of the biodegradable PHA layers of the multilayer film are comprised of a blend of 34-38% by weight poly-3-hydroxybutyrate (P3HB), 22-26% by weight copolymer of 3-hydroxybutyrate (3HB) and 4-hydroxybutyrate (4HB) with a weight % 4HB of 8-14% and 38-42% by weight copolymer of 3-hydroxybutyrate (3HB) and 4-hydroxybutyrate (4HB) with a weight % of 4HB 25-33%.

In a second aspect, one or more of the polyhydroxyalkanoate layers are comprised of at least one copolymer of 3-hydroxybutyrate (3HB) and 4-hydroxybutyrate (4HB).

In a first embodiment of the first or second aspect, the core film layer of the multilayer film is comprised of a biodegradable, extrudable, water soluble polyvinyl alcohol (PVOH) (e.g., Nippon Nichigo G-polymer® PVOH) resin with high oxygen gas barrier properties. The core can optionally include other layers or coating or it is the same layer that will have barrier layers for light, oxygen and moisture. This core does not include a layer of metal oxide.

In a second embodiment of the first or second aspect of the invention and of the first embodiment, the outer PHA films layers and the PVOH core film layer are bonded together using an adhesive such as ethylene vinyl acetate copolymer resin grafted with maleic anhydride (EVAc-MA) or other maleic anhydride grafted biodegradable resins such as PHA's or reactive blends of PHA's with PVOH.

In a third embodiment of the invention, the PHA materials of the first or second aspect are prepared from genetically engineered microbes specifically designed to produce poly-3-hydroxybutyrates and poly-3-hydroxybutyrates-co-4-hydroxybutyrates.

In a fourth embodiment or the first or second aspect of the invention, the PHA film layers of the invention further include a branching agent and a cross-linking agent (e.g., diethylene glycol dimethacrylate, pentaerythritol tetraacrylate, and the like). In such embodiments, the branching agent is selected from: dicumyl peroxide, t-amyl-2-ethylhexyl peroxycarbonate, 1,1-bis(t-butylperoxy)-3,3,5-trimethylcyclohexane, 2,5-dimethyl-2,5-di(t-butylperoxy) hexane, 2,5-bis(t-butylperoxy)-2,5-dimethylhexane, 2,5-dimethyl-di(t-butylperoxy)hexyne-3, di-t-butyl peroxide, benzoyl peroxide, di-t-amyl peroxide, t-butyl cumyl peroxide, n-butyl-4,4-bis(t-butylperoxy)valerate, 1,1-di(t-butylperoxy)-3,3,5-trimethyl-cyclohexane, 1,1-di(t-butylperoxy)cyclohexane, 1,1-di(t-amylperoxy)-cyclohexane, 2,2-di(t-butylperoxy)butane, ethyl-3,3-di(t-butylperoxy)butyrate, 2,2-di(t-amylperoxy)propane, ethyl-3,3-di(t-amylperoxy)butyrate, t-butylperoxy-acetate, t-amylperoxyacetate, t-butylperoxybenzoate, t-amylperoxybenzoate, and di-t-butyldiperoxyphthalate or combinations thereof.

In certain embodiments, the PHA film layers of the invention described by the aspects and embodiment abover are made by melt reacting the PHA blend with a branching agent optionally in the presence of a co-agent (also referred to herein, as a “cross-linking agent”), thereby forming a branched PHA polymer blend. The conditions of the reaction are suitable for reacting the branching agent alone or with a cross-linking agent and a PHA polymer blend. A “branched” polymer is a polymer with a branching of the polymer chain or cross-linking of two or more polymer chains.

The cross-linking agent when reacted, for example, at an epoxide group(s), epoxy functional compound, or double bond(s), becomes bonded to another molecule, e.g., a polymer or branched polymer. As a consequence the multiple molecules become cross-linked through the reactive group on the cross-linking agent. An “epoxy functional compound” is a cross-linking agent comprising two or more epoxy functional groups.

In certain embodiments, the functional group of the cross-linking agent is an epoxy-functional compound, for example, an epoxy-functional styrene-acrylic polymer, an epoxy-functional acrylic copolymer, an epoxy-functional polyolefin copolymer, oligomers comprising glycidyl groups with epoxy functional side chains, an epoxy-functional poly(ethylene-glycidyl methacrylate-co-methacrylate), or an epoxidized oil, poly(ethylene-co-methacrylate-coglycidyl methacrylate, ethylene-n-butyl acrylate-glycidyl methacrylate or combinations thereof.

In other embodiment, the cross-linking agent contains at least two reactive double bonds. These cross-linking agents include but is not limited to the following: diallyl phthalate, pentaerythritol tetraacrylate, trimethylolpropane triacrylate, pentaerythritol triacrylate, dipentaerythritol pentaacrylate, diethylene glycol dimethacrylate, bis(2-methacryloxyethyl) phosphate, or combinations thereof.

Additives may also be included in any or all of the film layers of any of the embodiments and aspects described above and methods of making the films of the inventions. The types of additives include but are not limited to plasticizers, clarifiers, nucleating agents, thermal stabilizers, inorganic fillers, anti-slip agents, anti-blocking and agents. Combinations of each can be selected for the particular end use of the product. For example, if it is a food based application, certain additives are approved for food contact and can be selected. In particular embodiments, a nucleating agent is added (e.g., BN or cyanuric acid).

In still another embodiment, a method of making a multilayer, fully biodegradable film is described. The method includes co-extruding four films (two PHA blends, one PVOH core and one EVAc-MA, split into two) and combining them in a 5-layer blown film feedblock to produce the multilayer film shown in FIG. 1. In a particular embodiment, the PHA blend is a blend of 34-38% by weight poly-3-hydroxybutyrate (P3HB), 22-26% by weight copolymer of 3-hydroxybutyrate (3HB) and 4-hydroxybutyrate (4HB) with a weight % 4HB of 8-14% and 38-42% by weight copolymer of 3-hydroxybutyrate (3HB) and 4-hydroxybutyrate (4HB) with a weight % of 4HB 25-33% and is optionally branched with a peroxide and a cross-linking agent.

In other aspects additional layers can be added to the compositions for barrier purposes or other advantageous reasons.

In certain embodiments, the multilayer compositions are fully biodegradable. In other embodiments, the compositions are 80%, 85%, 90%, 95%, 96%, 97%, 98% 99% or 100% biodegradable. The layers are easily extruded and form a compatible multilayer film that can be used for many applications, including food storage.

In other embodiments, the multilayer compositions of the invention are free of metal oxide. In certain embodiment, the composition is substantially free (about 95% free, 96% free, 97% free, 98% free, 99%,). In other embodiments, the composition contains less than one percent, less than 0.1 percent or less than 0.01 percent metal oxide in the total composition.

In certain embodiments, the polyhydroxyalkanoate polymer blend does not comprise polylactide. For example, the adhesive layer can further comprise a polyhydroxyalkanoate but not only a polylactide polymer.

In a certain aspect, the multilayer film includes, biodegradable PHA layers comprising a blend of 34-38% by weight poly-3-hydroxybutyrate (P3HB), 22-26% by weight copolymer of 3-hydroxybutyrate (3HB) and 4-hydroxybutyrate (4HB) with a weight % 4HB of 8-14% and 38-42% by weight copolymer of 3-hydroxybutyrate (3HB) and 4-hydroxybutyrate (4HB) with a weight % of 4HB 25-33%, that are optionally branched with a peroxide and crosslinking agent, water soluble polyvinyl alcohol (PVOH) layer, wherein the outer PHA films layers and the PVOH core film layer are bonded together using an adhesive such as ethylene vinyl acetate copolymer resin grafted with maleic anhydride (EVAc-MA) or other maleic anhydride grafted biodegradable resins. The PHA layer further includes additives such as one or more of the following nucleating agents, anti-blocking agents, plasticizers, talcs, waxes, calcium carbonates and the like. The select combinations of these additives with the film layers provide an improved bio-based film article. Such improvements include biodegradability, improved barrier properties, improved processing (e.g., flexibility) and durability for the selected purpose.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram showing a cross section of the fully biodegradable, high oxygen barrier multilayer film. The outer film layers are composed of a blend of 34-38% by weight poly-3-hydroxybutyrate (P3HB), 22-26% by weight copolymer of 3-hydroxybutyrate (3HB) and 4-hydroxybutyrate (4HB) with a weight % 4HB of 8-14% and 38-42% by weight copolymer of 3-hydroxybutyrate (3HB) and 4-hydroxybutyrate (4HB) with a weight % of 4HB 25-33%; the core layer is composed of a polyvinyl alcohol (PVOH) high oxygen barrier film; bonding the outer layers to the core layer is an adhesive, maleic anhydride grafted-ethylene vinyl acetate copolymer film (EvAc-MA).

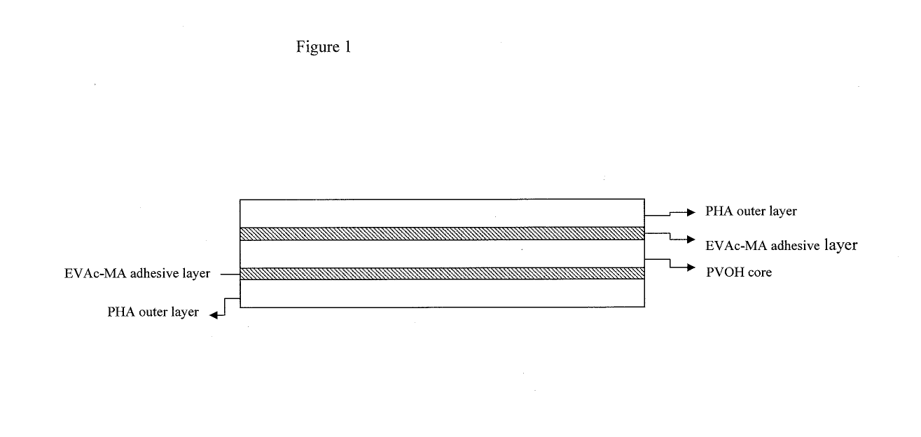

### DETAILED DESCRIPTION OF THE INVENTION

Described herein are multilayer film compositions that are fully biodegradable having high oxygen barrier properties and a method to produce the films. Biodegradable films are known to have poor barrier properties and so can be modified by combining them in a multilayer film structure with a film that has good barrier properties. One such film material is polyvinyl alcohol. Recently, Soarus LLC has introduced a new polymer named G-polymer® polymer.

In certain aspects, the layers are combined and heated to form a laminate. The laminate can be 5 to 25 layers, for example 5 layers, 6 layers, 7 layers, 8 layers, 10 layers, 11 layers, 12 layers, 13 layers, 14 layers, 15 layers, 16 layers, 17 layers, 18 layers, 19 layers, 20 layers, 21 layers, 22 layers, 23 layers, 24 layers, and 25 layers. The overall size of the laminate is about 100 microns to about 500 microns, for example about 100 to about 500 microns, 200 to about 600 microns, 250 to about 750 microns. Each individual layer can be about 10 to about 100 microns, about 10 to about 20 micron, about 20 to about 40 microns, about 20 to about 50 microns, about 30 to about 60 microns, about 45 to about 70 microns, about 50 to about 75 microns, about 70 to about 100 microns. For example, the layer is about 36 microns, about 8 microns, or about 12 microns. For each laminate, at least one layer is a multilayer of composition of the invention. In certain embodiments, the laminates of the invention comprise more than one layer.

### Polyhydroxyalkanoates (PHAS)

In certain embodiments, the outer layers of the invention comprise a polyhydroxyalkanoate. In these embodiments, the PHA is other than only poly lactic acid. Polyhydroxyalkanoates are biological polyesters synthesized by a broad range of natural and genetically engineered bacteria as well as genetically engineered plant crops (Braunegg et al., (1998), J. Biotechnology 65:127-161; Madison and Huisman, 1999, Microbiology and Molecular Biology Reviews, 63:21-53; Poirier, 2002, Progress in Lipid Research 41:131-155). These polymers are biodegradable thermoplastic materials, produced from renewable resources, with the potential for use in a broad range of industrial applications (Williams & Peoples, CHEMTECH 26:38-44 (1996)).

Useful microbial strains for producing PHAs, include Alcaligenes eutrophus (renamed as Ralstonia eutropha), Alcaligenes latus, Azotobacter, Aeromonas, Comamonas, Pseudomonads, and genetically engineered organisms including genetically engineered microbes such as Pseudomonas, Ralstonia and Escherichia coli.

In general, a PHA is formed by enzymatic polymerization of one or more monomer units inside a living cell. Over 100 different types of monomers have been incorporated into the PHA polymers (Steinbiichel and Valentin, 1995, FEMS Microbiol. Lett. 128:219-228. Examples of monomer units incorporated in PHAs include 2-hydroxybutyrate, lactic acid, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HHep), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP), poly 3-hydroxybutyrate (hereinafter referred to as P3HB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)).

In certain embodiments, the starting PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

By selecting the monomer types and controlling the ratios of the monomer units in a given PHA copolymer a wide range of material properties can be achieved. Although examples of PHA copolymers having two different monomer units have been provided, the PHA can have more than two different monomer units (e.g., three different monomer units, four different monomer units, five different monomer units, six different monomer units) An example of a PHA having 4 different monomer units would be PHB-co-3HH-co-3HO-co-3HD or PHB-co-3-HO-co-3HD-co-3HDd (these types of PHA copolymers are hereinafter referred to as PHB3HX). Typically where the PHB3HX has 3 or more monomer units the 3HB monomer is at least 70% by weight of the total monomers, preferably 85% by weight of the total monomers, most preferably greater than 90% by weight of the total monomers for example 92%, 93%, 94%, 95%, 96% by weight of the copolymer and the HX comprises one or more monomers selected from 3HH, 3HO, 3HD, 3HDd.

The homopolymer (where all monomer units are identical) P3HB and 3-hydroxybutyrate copolymers (P3HB3HP, P3HB4HB, P3HB3HV, P3HB4HV, P3HB5HV, P3HB3HHP, hereinafter referred to as PHB copolymers) containing 3-hydroxybutyrate and at least one other monomer are of particular interest for commercial production and applications. It is useful to describe these copolymers by reference to their material properties as follows. Type 1 PHB copolymers typically have a glass transition temperature (Tg) in the range of 6° C. to −10° C., and a melting temperature T_{M} of between 80° C. to 180° C. Type 2 PHB copolymers typically have a Tg of −20° C. to −50° C. and Tm of 55° C. to 90° C. In a particular embodiment, the Type 2 copolymer has a phase component with a T_{g} of −15° C. to −45° C. and no Tm.

Preferred Type 1 PHB copolymers have two monomer units have a majority of their monomer units being 3-hydroxybutyrate monomer by weight in the copolymer, for example, greater than 78% 3-hydroxybutyrate monomer. Preferred PHB copolymers for this invention are biologically produced from renewable resources and are selected from the following group of PHB copolymers:

PHB3HV is a Type 1 PHB copolymer where the 3HV content is in the range of 3% to 22% by weight of the polymer and preferably in the range of 4% to 15% by weight of the copolymer for example: 4% 3HV; 5% 3HV; 6% 3HV; 7% 3HV; 8% 3HV; 9% 3HV; 10% 3HV; 11% 3HV; 12% 3HV; 13% 3HV; 14% 3HV; 15% 3HV;

PHB3HP is a Type 1 PHB copolymer where the 3HP content is in the range of 3% to 15% by weight of the copolymer and preferably in the range of 4% to 15% by weight of the copolymer for example: 4% 3HP; 5% 3HP; 6% 3HP; 7% 3HP; 8% 3HP; 9% 3HP; 10% 3HP; 11% 3HP; 12% 3HP. 13% 3HP; 14% 3HP; 15% 3HP.

PHB4HB is a Type 1 PHB copolymer where the 4HB content is in the range of 3% to 15% by weight of the copolymer and preferably in the range of 4% to 15% by weight of the copolymer for example: 4% 4HB; 5% 4HB; 6% 4HB; 7% 4HB; 8% 4HB; 9% 4HB; 10% 4HB; 11% 4HB; 12% 4HB; 13% 4HB; 14% 4HB; 15% 4HB.

PHB4HV is a Type 1 PHB copolymer where the 4HV content is in the range of 3% to 15% by weight of the copolymer and preferably in the range of 4% to 15% by weight of the copolymer for example: 4% 4HV; 5% 4HV; 6% 4HV; 7% 4HV; 8% 4HV; 9% 4HV; 10% 4HV; 11% 4HV; 12% 4HV; 13% 4HV; 14% 4HV; 15% 4HV.

PHB5HV is a Type 1 PHB copolymer where the 5HV content is in the range of 3% to 15% by weight of the copolymer and preferably in the range of 4% to 15% by weight of the copolymer for example: 4% 5HV; 5% 5HV; 6% 5HV; 7% 5HV; 8% 5HV; 9% 5HV; 10% 5HV; 11% 5HV; 12% 5HV; 13% 5HV; 14% 5HV; 15% 5HV.

PHB3HH is a Type 1 PHB copolymer where the 3HH content is in the range of 3% to 15% by weight of the copolymer and preferably in the range of 4% to 15% by weight of the copolymer for example: 4% 3HH; 5% 3HH; 6% 3HH; 7% 3HH; 8% 3HH; 9% 3HH; 10% 3HH; 11% 3HH; 12% 3HH; 13% 3HH; 14% 3HH; 15% 3HH;

PHB3HX is a Type 1 PHB copolymer where the 3HX content is comprised of 2 or more monomers selected from 3HH, 3HO, 3HD and 3HDd and the 3HX content is in the range of 3% to 12% by weight of the copolymer and preferably in the range of 4% to 10% by weight of the copolymer for example: 4% 3HX; 5% 3HX; 6% 3HX; 7% 3HX; 8% 3HX; 9% 3HX; 10% 3HX by weight of the copolymer.

Type 2 PHB copolymers have a 3HB content of between 80% and 5% by weight of the copolymer, for example 80%, 75%, 70%, 65%, 60%, 55%, 50%, 45%, 40%, 35%, 30%, 25%, 20%, 15%, 10%, 5% by weight of the copolymer.

PHB4HB is a Type 2 PHB copolymer where the 4HB content is in the range of 20% to 60% by weight of the copolymer and preferably in the range of 25% to 50% by weight of the copolymer for example: 25% 4HB; 30% 4HB; 35% 4HB; 40% 4HB; 45% 4HB; 50% 4HB by weight of the copolymer.

PHB5HV is a Type 2 PHB copolymer where the 5HV content is in the range of 20% to 60% by weight of the copolymer and preferably in the range of 25% to 50% by weight of the copolymer for example: 25% 5HV; 30% 5HV; 35% 5HV; 40% 5HV; 45% 5HV; 50% 5HV by weight of the copolymer.

PHB3HH is a Type 2 PHB copolymer where the 3HH is in the range of 35% to 95% by weight of the copolymer and preferably in the range of 40% to 80% by weight of the copolymer for example: 40% 3HH; 45% 3HH; 50% 3HH; 55% 3HH, 60% 3HH; 65% 3HH; 70% 3HH; 75% 3HH; 80% 3HH by weight of the copolymer.

PHB3HX is a Type 2 PHB copolymer where the 3HX content is comprised of 2 or more monomers selected from 3HH, 3HO, 3HD and 3HDd and the 3HX content is in the range of 30% to 95% by weight of the copolymer and preferably in the range of 35% to 90% by weight of the copolymer for example: 35% 3HX; 40% 3HX; 45% 3HX; 50% 3HX; 55% 3HX 60% 3HX; 65% 3HX; 70% 3HX; 75% 3HX; 80% 3HX; 85% 3HX; 90% 3HX by weight of the copolymer.

PHAs for use in the methods, compositions and pellets described in this invention are selected from : PHB or a Type 1 PHB copolymer; a PHA blend of PHB with a Type 1 PHB copolymer where the PHB content by weight of PHA in the PHA blend is in the range of 5% to 95% by weight of the PHA in the PHA blend; a PHA blend of PHB with a Type 2 PHB copolymer where the PHB content by weight of the PHA in the PHA blend is in the range of 5% to 95% by weight of the PHA in the PHA blend; a PHA blend of a Type 1 PHB copolymer with a different Type 1 PHB copolymer and where the content of the first Type 1 PHB copolymer is in the range of 5% to 95% by weight of the PHA in the PHA blend; a PHA blend of a Type 1 PHB copolymer with a Type 2 PHA copolymer where the content of the Type 1 PHB copolymer is in the range of 30% to 95% by weight of the PHA in the PHA blend; a PHA blend of PHB with a Type 1 PHB copolymer and a Type 2 PHB copolymer where the PHB content is in the range of 10% to 90% by weight of the PHA in the PHA blend, where the Type 1 PHB copolymer content is in the range of 5% to 90% by weight of the PHA in the PHA blend and where the Type 2 PHB copolymer content is in the range of 5% to 90% by weight of the PHA in the PHA blend.

The PHA blend of PHB with a Type 1 PHB copolymer is a blend of PHB with PHB3HP where the PHB content in the PHA blend is in the range of 5% to 90% by weight of the PHA in the PHA blend and the 3HP content in the PHB3HP is in the range of 7% to 15% by weight of the PHB3HP.

The PHA blend of PHB with a Type 1 PHB copolymer is a blend of PHB with PHB3HV where the PHB content of the PHA blend is in the range of 5% to 90% by weight of the PHA in the PHA blend and the 3HV content in the PHB3HV is in the range of 4% to 22% by weight of the PHB3HV.

The PHA blend of PHB with a Type 1 PHB copolymer is a blend of PHB with PHB4HB where the PHB content of the PHA blend is in the range of 5% to 90% by weight of the PHA in the PHA blend and the 4HB content in the PHB4HB is in the range of 4% to 15% by weight of the PHB4HB.

The PHA blend of PHB with a Type 1 PHB copolymer is a blend of PHB with PHB4HV where the PHB content of the PHA blend is in the range of 5% to 90% by weight of the PHA in the PHA blend and the 4HV content in the PHB4HV is in the range of 4% to 15% by weight of the PHB4HV.

The PHA blend of PHB with a Type 1 PHB copolymer is a blend of PHB with PHB5HV where the PHB content of the PHA blend is in the range of 5% to 90% by weight of the PHA in the PHA blend and the 5HV content in the PHB5HV is in the range of 4% to 15% by weight of the PHB5HV.

The PHA blend of PHB with a Type 1 PHB copolymer is a blend of PHB with PHB3HH where the PHB content of the PHA blend is in the range of 5% to 90% by weight of the PHA in the PHA blend and the 3HH content in the PHB3HH is in the range of 4% to 15% by weight of the PHB3HH.

The PHA blend of PHB with a Type 1 PHB copolymer is a blend of PHB with PHB3HX where the PHB content of the PHA blend is in the range of 5% to 90% by weight of the PHA in the PHA blend and the 3HX content in the PHB3HX is in the range of 4% to 15% by weight of the PHB3HX.

The PHA blend is a blend of a Type 1 PHB copolymer selected from the group PHB3HV, PHB3HP, PHB4HB, PHBV, PHV4HV, PHB5HV, PHB3HH and PHB3HX with a second Type 1 PHB copolymer which is different from the first Type 1 PHB copolymer and is selected from the group PHB3HV, PHB3HP, PHB4HB, PHBV, PHV4HV, PHB5HV, PHB3HH and PHB3HX where the content of the First Type 1 PHB copolymer in the PHA blend is in the range of 10% to 90% by weight of the total PHA in the blend.

The PHA blend of PHB with a Type 2 PHB copolymer is a blend of PHB with PHB4HB where the PHB content in the PHA blend is in the range of 30% to 95% by weight of the PHA in the PHA blend and the 4HB content in the PHB4HB is in the range of 20% to 60% by weight of the PHB4HB.

The PHA blend of PHB with a Type 2 PHB copolymer is a blend of PHB with PHB5HV where the PHB content in the PHA blend is in the range of 30% to 95% by weight of the PHA in the PHA blend and the 5HV content in the PHB5HV is in the range of 20% to 60% by weight of the PHB5HV.

The PHA blend of PHB with a Type 2 PHB copolymer is a blend of PHB with PHB3HH where the PHB content in the PHA blend is in the range of 35% to 95% by weight of the PHA in the PHA blend and the 3HH content in the PHB3HH is in the range of 35% to 90% by weight of the PHB3HX.

The PHA blend of PHB with a Type 2 PHB copolymer is a blend of PHB with PHB3HX where the PHB content in the PHA blend is in the range of 30% to 95% by weight of the PHA in the PHA blend and the 3HX content in the PHB3HX is in the range of 35% to 90% by weight of the PHB3HX.

The PHA blend is a blend of PHB with a Type 1 PHB copolymer and a Type 2 PHB copolymer where the PHB content in the PHA blend is in the range of 10% to 90% by weight of the PHA in the PHA blend, the Type 1 PHB copolymer content of the PHA blend is in the range of 5% to 90% by weight of the PHA in the PHA blend and the Type 2 PHB copolymer content in the PHA blend is in the range of 5% to 90% by weight of the PHA in the PHA blend.

For example, a PHA blend can have a PHB content in the PHA blend in the range of 10% to 90% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHBHX content in the PHA blend in the range of 5% to 90% by weight of the PHA in the PHA blend where the 3HX content in the PHBHX is in the range of 35% to 90% by weight of the PHBHX.

For example, a PHA blend can have a PHB content in the PHA blend in the range of 10% to 90% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHB4HB content in the PHA blend in the range of 5% to 90% by weight of the PHA in the PHA blend where the 4HB content in the PHB4HB is in the range of 20% to 60% by weight of the PHB4HB.

For example, a PHA blend can have a PHB content in the PHA blend in the range of 10% to 90% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHB5HV content in the PHA blend in the range of 5% to 90% by weight of the PHA in the PHA blend where the 5HV content in the PHB5HV is in the range of 20% to 60% by weight of the PHB5HV.

For example, a PHA blend can have a PHB content in the PHA blend in the range of 10% to 90% by weight of the PHA in the PHA blend, a PHB4HB content in the PHA blend in the range 5% to 90% by weight of the PHA in the PHA blend, where the 4HB content in the PHB4HB is in the range of 4% to 15% by weight of the PHB4HB, and a PHB4HB content in the PHA blend in the range of 5% to 90% by weight of the PHA in the PHA blend where the 4HB content in the PHB4HB is in the range of 20% to 60% by weight of the PHB4HB.

For example, a PHA blend can have a PHB content in the PHA blend in the range of 10% to 90% by weight of the PHA in the PHA blend, a PHB4HB content in the PHA blend in the range 5% to 90% by weight of the PHA in the PHA blend, where the 4HB content in the PHB4HB is in the range of 4% to 15% by weight of the PHB4HB, and a PHB5HV content in the PHA blend in the range of 5% to 90% by weight of the PHA in the PHA blend and where the 5HV content in the PHB5HV is in the range of 30% to 90% by weight of the PHB5HV.

For example, a PHA blend can have a PHB content in the PHA blend in the range of 10% to 90% by weight of the PHA in the PHA blend, a PHB4HB content in the PHA blend in the range 5% to 90% by weight of the PHA in the PHA blend, where the 4HB content in the PHB4HB is in the range of 4% to 15% by weight of the PHB4HB, and a PHB3HX content in the PHA blend in the range of 5% to 90% by weight of the PHA in the PHA blend and where the 3HX content in the PHB3HX is in the range of 35% to 90% by weight of the PHB3HX.

For example, a PHA blend can have a PHB content in the PHA blend in the range of 10% to 90% by weight of the PHA in the PHA blend, a PHB4HV content in the PHA blend in the range 5% to 90% by weight of the PHA in the PHA blend, where the 4HV content in the PHB4HV is in the range of 3% to 15% by weight of the PHB4HV, and a PHB5HV content in the PHA blend in the range of 5% to 90% by weight of the PHA in the PHA blend where the 5HV content in the PHB5HV is in the range of 30% to 90% by weight of the PHB5HV.

For example, a PHA blend can have a PHB content in the PHA blend in the range of 10% to 90% by weight of the PHA in the PHA blend, a PHB3HH content in the PHA blend in the range 5% to 90% by weight of the PHA in the PHA blend, where the 3HH content in the PHB3HH is in the range of 3% to 15% by weight of the PHB3HH, and a PHB4HB content in the PHA blend in the range of 5% to 90% by weight of the PHA in the PHA blend where the 4HB content in the PHB4HB is in the range of 20% to 60% by weight of the PHB4HB.

For example, a PHA blend can have a PHB content in the PHA blend in the range of 10% to 90% by weight of the PHA in the PHA blend, a PHB3HH content in the PHA blend in the range 5% to 90% by weight of the PHA in the PHA blend, where the 3HH content in the PHB3HH is in the range of 3% to 15% by weight of the PHB3HH, and a PHB5HV content in the PHA blend in the range of 5% to 90% by weight of the PHA in the PHA blend where the 5HV content in the PHB5HV is in the range of 20% to 60% by weight of the PHB5HV.

For example, a PHA blend can have a PHB content in the PHA blend in the range of 10% to 90% by weight of the PHA in the PHA blend, a PHB3HH content in the PHA blend in the range 5% to 90% by weight of the PHA in the PHA blend, where the 3HH content in the PHB3HH is in the range of 3% to 15% by weight of the PHB3HH, and a PHB3HX content in the PHA blend in the range of 5% to 90% by weight of the PHA in the PHA blend where the 3HX content in the PHB3HX is in the range of 35% to 90% by weight of the PHB3HX.

For example, a PHA blend can have a PHB content in the PHA blend in the range of 10% to 90% by weight of the PHA in the PHA blend, a PHB3HX content in the PHA blend in the range 5% to 90% by weight of the PHA in the PHA blend, where the 3HX content in the PHB3HX is in the range of 3% to 12% by weight of the PHB3HX, and a PHB3HX content in the PHA blend in the range of 5% to 90% by weight of the PHA in the PHA blend where the 3HX content in the PHB3HX is in the range of 35% to 90% by weight of the PHB3HX.

For example, a PHA blend can have a PHB content in the PHA blend in the range of 10% to 90% by weight of the PHA in the PHA blend, a PHB3HX content in the PHA blend in the range 5% to 90% by weight of the PHA in the PHA blend, where the 3HX content in the PHB3HX is in the range of 3% to 12% by weight of the PHB3HX, and a PHB4HB content in the PHA blend in the range of 5% to 90% by weight of the PHA in the PHA blend where the 4HB content in the PHB4HB is in the range of 20% to 60% by weight of the PHB4HB.

For example, a PHA blend can have a PHB content in the PHA blend in the range of 10% to 90% by weight of the PHA in the PHA blend, a PHB3HX content in the PHA blend in the range 5% to 90% by weight of the PHA in the PHA blend, where the 3HX content in the PHB3HX is in the range of 3% to 12% by weight of the PHB3HX, and a PHB5HV content in the PHA blend in the range of 5% to 90% by weight of the PHA in the PHA blend where the 5HV content in the PHB5HV is in the range of 20% to 60% by weight of the PHB5HV.

The PHA blend is a blend as disclosed in U.S. Published Application No. US 2004/0220355, by Whitehouse, published Nov. 4, 2004, which is incorporated herein by reference in its entirety.

Microbial systems for producing the PHB copolymer PHBV are disclosed in, e.g., U.S. Pat. No. 4,477,654 to Holmes, which is incorporated herein by reference in its entirety. U.S. Published Application No. US 2002/0164729 (also incorporated herein by reference in its entirety) by Skraly and Sholl describes useful systems for producing the PHB copolymer PHB4HB. Useful processes for producing the PHB copolymer PHB3HH have been described (Lee et al., 2000, Biotechnology and Bioengineering 67:240-244; Park et al., 2001, Biomacromolecules 2:248-254). Processes for producing the PHB copolymers PHB3HX have been described by Matsusaki et al. (Biomacromolecules 2000, 1:17-22).

In determining the molecular weight techniques such as gel permeation chromatography (GPC) can be used. In the methodology, a polystyrene standard is utilized. The PHA can have a polystyrene equivalent weight average molecular weight (in daltons) of at least 500, at least 10,000, or at least 50,000 and/or less than 2,000,000, less than 1,000,000, less than 1,500,000, and less than 800,000. In certain embodiments, preferably, the PHAs generally have a weight-average molecular weight in the range of 100,000 to 700,000. For example, the molecular weight range for PHB and Type 1 PHB copolymers for use in this application are in the range of 400,000 daltons to 1.5 million daltons as determined by GPC method and the molecular weight range for Type 2 PHB copolymers for use in the application 100,000 to 1.5 million daltons.

In certain embodiments, the PHA can have a linear equivalent weight average molecular weight of from about 150,000 Daltons to about 500,000 Daltons and a polydispersity index of from about 2.5 to about 8.0. As used herein, weight average molecular weight and linear equivalent weight average molecular weight are determined by gel permeation chromatography, using, e.g., chloroform as both the eluent and diluent for the PHA samples. Calibration curves for determining molecular weights are generated using linear polystyrenes as molecular weight standards and a ‘log MW vs elution volume’ calibration method.

### Branched Polyhydroxyalkanoates

The term “branched polymer” refers to a PLA or PHA with branching of the chain and/or cross-linking of two or more chains. Branching on side chains is also contemplated. Branching can be accomplished by various methods. PHA polymer blends (with optionally PLA) described above can be branched by branching agents by free-radical-induced cross-linking of the polymer. Polyhydroxyalkanoate polymers can be branched in any of the ways described in U.S. Pat. Nos. 6,620,869, 7,208,535, 6,201,083, 6,156,852, 6,248,862, 6,201,083 and 6,096,810 all of which are incorporated herein by reference in their entirety.

The polymers of the invention can also be branched according to any of the methods disclosed in International Publication No. WO 2010/008447, titled “Methods For Branching PHA Using Thermolysis” or International Publication No. WO 2010/008445, titled “Branched PHA Compositions, Methods For Their Production, And Use In Applications,” both of which were published in English on Jan. 21, 2010, and designated the United States. These applications are incorporated by reference herein in their entirety.

### Branching Agents

The branching agents, also referred to as free radical initiators, for use in the compositions and method described herein include organic peroxides. Peroxides are reactive molecules, and react with polymer molecules or previously branched polymers by removing a hydrogen atom from the polymer backbone, leaving behind a radical. Polymer molecules having such radicals on their backbone are free to combine with each other, creating branched polymer molecules. Branching agents are selected from any suitable initiator known in the art, such as peroxides, azo-dervatives (e.g., azo-nitriles), peresters, and peroxycarbonates. Suitable peroxides for use in the present invention include, but are not limited to, organic peroxides, for example dialkyl organic peroxides such as 2,5-dimethyl-2,5-di(t-butylperoxy) hexane, 2,5-bis(t-butylperoxy)-2,5-dimethylhexane (available from Akzo Nobel as TRIGANOX® 101), 2,5-dimethyl-di(t-butylperoxy)hexyne-3, di-t-butyl peroxide, dicumyl peroxide, benzoyl peroxide, di-t-amyl peroxide, t-amylperoxy-2-ethylhexylcarbonate (TAEC), t-butyl cumyl peroxide, n-butyl-4,4-bis(t-butylperoxy)valerate, 1,1-di(t-butylperoxy)-3,3,5-trimethyl-cyclohexane, 1,1-bis(t-butylperoxy)-3,3,5-trimethylcyclohexane (CPK), 1,1-di(t-butylperoxy)cyclohexane, 1,1-di(t-amylperoxy)-cyclohexane, 2,2-di(t-butylperoxy)butane, ethyl-3,3-di(t-butylperoxy)butyrate, 2,2-di(t-amylperoxy)propane, ethyl-3,3-di(t-amylperoxy)butyrate, t-butylperoxy-acetate, t-amylperoxyacetate, t-butylperoxybenzoate, t-amylperoxybenzoate, di-t-butyldiperoxyphthalate, and the like. Combinations and mixtures of peroxides can also be used. Examples of free radical initiators include those mentioned herein, as well as those described in, e.g., Polymer Handbook, 3^{rd} Ed., J. Brandrup & E. H. Immergut, John Wiley and Sons, 1989, Ch. 2. Irradiation (e.g., e-beam or gamma irradiation) can also be used to generate polymer branching.

The efficiency of branching and crosslinking of the polymer blend (e.g., PHA and/or PHA/PLA or other polymer) can also be significantly enhanced by the dispersion of organic peroxides in a cross-linking agent, such as a polymerizable (i.e., reactive) plasticizers. The polymerizable plasticizer should contain a reactive functionality, such as a reactive unsaturated double bond, which increases the overall branching and crosslinking efficiency.

As discussed above, when peroxides decompose, they form very high energy radicals that can extract a hydrogen atom from the polymer backbone. These radicals have short half-lives, thereby limiting the population of branched molecules that is produced during the active time period.

### Additives

In certain embodiments, various additives are added to the compositions and include one or more of the same additive and combinations of additives. Examples of these additives include, but are not limited to, antioxidants, pigments, thermal and UV stabilizers, inorganic and organic fillers, plasticizers, nucleating agents, anti-slip agents, anti-blocking agents and radical scavengers. Additionally, polyfunctional co-agents such as divinyl benzene, trially cyanurate and the like may be added. Such co-agents can be added to one or more of these additives for easier incorporation into the polymer. For instance, the co-agent can be mixed with a plasticizer, e.g., a non-reactive plasticizer, e.g., a citric acid ester, and then compounded with the polymer under conditions to induce branching.

In poly-3-hydroxybutyrate compositions and blends, for example, plasticizers are often used to change the glass transition temperature and modulus of the composition, but surfactants may also be used. Lubricants may also be used, e.g., in injection molding applications. Plasticizers, surfactants and lubricants may all therefore be included in the overall composition.

In other embodiments, the compositions and methods of the invention include one or more plasticizers. Examples of plasticizers include phthalic compounds (including, but not limited to, dimethyl phthalate, diethyl phthalate, dibutyl phthalate, dihexyl phthalate, di-n-octyl phthalate, di-2-ethylhexyl phthalate, diisooctyl phthalate, dicapryl phthalate, dinonyl phthalate, diisononyl phthalate, didecyl phthalate, diundecyl phthalate, dilauryl phthalate, ditridecyl phthalate, dibenzyl phthalate, dicyclohexyl phthalate, butyl benzyl phthalate, octyl decyl phthalate, butyl octyl phthalate, octyl benzyl phthalate, n-hexyl n-decyl phthalate, n-octyl phthalate, and n-decyl phthalate), phosphoric compounds (including, but not limited to, tricresyl phosphate, trioctyl phosphate, triphenyl phosphate, octyl diphenyl phosphate, cresyl diphenyl phosphate, and trichloroethyl phosphate), adipic compounds (including, but not limited to, dibutoxyethoxyethyl adipate (DBEEA), dioctyl adipate, diisooctyl adipate, di-n-octyl adipate, didecyl adipate, diisodecyl adipate, n-octyl n-decyl adipate, n-heptyl adipate, and n-nonyl adipate), sebacic compounds (including, but not limited to, dibutyl sebacate, dioctyl sebacate, diisooctyl sebacate, and butyl benzyl sebacate), azelaic compounds, citric compounds (including, but not limited to, triethyl citrate, acetyl triethyl citrate, tributyl citrate, acetyl tributyl citrate, and acetyl trioctyl citrate), glycolic compounds (including, but not limited to, methyl phthalyl ethyl glycolate, ethyl phthalyl ethyl glycolate, and butyl phthalyl ethyl glycolate), trimellitic compounds (including, but not limited to, trioctyl trimellitate and tri-n-octyl n-decyl trimellitate), phthalic isomer compounds (including, but not limited to, dioctyl isophthalate and dioctyl terephthalate), ricinoleic compounds (including, but not limited to, methyl acetyl, recinoleate and butyl acetyl recinoleate), polyester compounds (including, but not limited to reaction products of diols selected from butane diol, ethylene glycol, propane 1,2 diol, propane 1,3 diol, polyethylene glycol, glycerol, diacids selected from adipic acid, succinic acid, succinic anhydride and hydroxyacids such as hydroxystearic acid, epoxidized soy bean oil, chlorinated paraffins, chlorinated fatty acid esters, fatty acid compounds, plant oils, pigments, and acrylic compounds. The plasticizers may be used either alone respectively or in combinations with each other.

In certain embodiments, the compositions and methods of the invention include one or more surfactants. Surfactants are generally used to de-dust, lubricate, reduce surface tension, and/or density. Examples of surfactants include, but are not limited to mineral oil, castor oil, and soybean oil. One mineral oil surfactant is Drakeol 34, available from Penreco (Dickinson, Tex., USA). Maxsperse W-6000 and W-3000 solid surfactants are available from Chemax Polymer Additives (Piedmont, S.C., USA). Non-ionic surfactants with HLB values ranging from about 2 to about 16 can be used, examples being TWEEN-20, TWEEN-65, Span-40 and Span 85.

Anionic surfactants include: aliphatic carboxylic acids such as lauric acid, myristic acid, palmitic acid, stearic acid, and oleic acid; fatty acid soaps such as sodium salts or potassium salts of the above aliphatic carboxylic acids; N-acyl-N-methylglycine salts, N-acyl-N-methyl-beta-alanine salts, N-acylglutamic acid salts, polyoxyethylene alkyl ether carboxylic acid salts, acylated peptides, alkylbenzenesulfonic acid salts, alkylnaphthalenesulfonic acid salts, naphthalenesulfonic acid salt-formalin polycondensation products, melaminesulfonic acid salt-formalin polycondensation products, dialkylsulfosuccinic acid ester salts, alkyl sulfosuccinate disalts, polyoxyethylene alkylsulfosuccinic acid disalts, alkylsulfoacetic acid salts, (alpha-olefinsulfonic acid salts, N-acylmethyltaurine salts, sodium dimethyl 5-sulfoisophthalate, sulfated oil, higher alcohol sulfuric acid ester salts, polyoxyethylene alkyl ether sulfuric acid salts, secondary higher alcohol ethoxysulfates, polyoxyethylene alkyl phenyl ether sulfuric acid salts, monoglysulfate, sulfuric acid ester salts of fatty acid alkylolamides, polyoxyethylene alkyl ether phosphoric acid salts, polyoxyethylene alkyl phenyl ether phosphoric acid salts, alkyl phosphoric acid salts, sodium alkylamine oxide bistridecylsulfosuccinates, sodium dioctylsulfosuccinate, sodium dihexylsulfosuccinate, sodium dicyclohexylsulfosuccinate, sodium diamylsulfosuccinate, sodium diisobutylsulfosuccinate, alkylamine guanidine polyoxyethanol, disodium sulfosuccinate ethoxylated alcohol half esters, disodium sulfosuccinate ethoxylated nonylphenol half esters, disodium isodecylsulfosuccinate, disodium N-octadecylsulfosuccinamide, tetrasodium N-(1,2-dicarboxyethyl)-N-octadecylsulfosuccinamide, disodium mono- or didodecyldiphenyl oxide disulfonates, sodium diisopropylnaphthalenesulfonate, and neutralized condensed products from sodium naphthalenesulfonate.

One or more lubricants can also be added to the compositions and methods of the invention. Lubricants are normally used to reduce sticking to hot processing metal surfaces and can include polyethylene, paraffin oils, and paraffin waxes in combination with metal stearates. Other lubricants include stearic acid, amide waxes, ester waxes, metal carboxylates, and carboxylic acids. Lubricants are normally added to polymers in the range of about 0.1 percent to about 1 percent by weight, generally from about 0.7 percent to about 0.8 percent by weight of the compound. Solid lubricants is warmed and melted before or during processing of the blend.

In film applications of the compositions and methods described herein, anti-block masterbatch is also added. A suitable example is a slip anti-block masterbatch mixture of erucamide (20% by weight) diatomaceous earth (15% by weight) nucleant masterbatch (3% by weight), pelleted into PHA (62% by weight). Others are known to those of ordinary skill in the field of polymer processing.

### Cross-Linking Agents

Cross-linking agents, also referred to as co-agents, used in the methods and compositions of the invention are cross-linking agents comprising two or more reactive functional groups such as epoxides or double bonds. These cross-linking agents modify the properties of the polymer. These properties include, but are not limited to, melt strength or toughness. One type of cross-linking agent is an “epoxy functional compound.” As used herein, “epoxy functional compound” is meant to include compounds with two or more epoxide groups capable of increasing the melt strength of polyhydroxyalkanoate polymers by branching, e.g., end branching as described above.

When an epoxy functional compound is used as the cross-linking agent in the disclosed methods, a branching agent is optional. As such one embodiment of the invention is a method of branching a starting polyhydroxyalkanoate polymer (PHA), comprising reacting a starting PHA with an epoxy functional compound. Alternatively, the invention is a method of branching a starting polyhydroxyalkanoate polymer, comprising reacting a starting PHA, a branching agent and an epoxy functional compound. Alternatively, the invention is a method of branching a starting polyhydroxyalkanoate polymer, comprising reacting a starting PHA, and an epoxy functional compound in the absence of a branching agent. Such epoxy functional compounds can include epoxy-functional, styrene-acrylic polymers (such as, but not limited to, e.g., JONCRYL® ADR-4368 (BASF), or MP-40 (Kaneka)), acrylic and/or polyolefin copolymers and oligomers containing glycidyl groups incorporated as side chains (such as, but not limited to, e.g., LOTADER® (Arkema), poly(ethylene-glycidyl methacrylate-co-methacrylate)), and epoxidized oils (such as, but not limited to, e.g., epoxidized soybean, olive, linseed, palm, peanut, coconut, seaweed, cod liver oils, or mixtures thereof, e.g., Merginat ESBO (Hobum, Hamburg, Germany)and EDENOL® B 316 (Cognis, Dusseldorf, Germany)).

For example, reactive acrylics or functional acrylics cross-linking agents are used to increase the molecular weight of the polymer in the branched polymer compositions described herein. Such cross-linking agents are sold commercially. BASF, for instance, sells multiple compounds under the trade name “JONCRYL®,” which are described in U.S. Pat. No. 6,984,694 to Blasius et al., “Oligomeric chain extenders for processing, post-processing and recycling of condensation polymers, synthesis, compositions and applications,” incorporated herein by reference in its entirety. One such compound is JONCRYL® ADR-4368CS, which is styrene glycidyl methacrylate and is discussed below. Another is MP-40 (Kaneka). And still another is

Petra line from Honeywell, see for example, U.S. Pat. No. 5,723,730. Such polymers are often used in plastic recycling (e.g., in recycling of polyethylene terephthalate) to increase the molecular weight (or to mimic the increase of molecular weight) of the polymer being recycled. Such polymers often have the general structure:

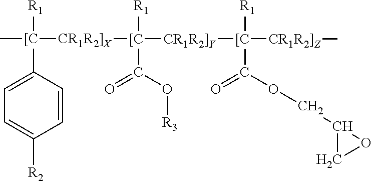

R₁ and R₂ are H or alkyl

R₃ is alkyl

x and y are 1-20

z is 2-20

E.I. du Pont de Nemours & Company sells multiple reactive compounds under the trade name ELVALOY®, which are ethylene copolymers, such as acrylate copolymers, elastomeric terpolymers, and other copolymers. One such compound is ELVALOY® PTW, which is a copolymer of ethylene-n-butyl acrylate and glycidyl methacrylate. Omnova sells similar compounds under the trade names “SX64053,” “SX64055,” and “SX64056.” Other entities also supply such compounds commercially.

Specific polyfunctional polymeric compounds with reactive epoxy functional groups are the styrene-acrylic copolymers. These materials are based on oligomers with styrene and acrylate building blocks that have glycidyl groups incorporated as side chains. A high number of epoxy groups per oligomer chain are used, for example 5, greater than 10, or greater than 20. These polymeric materials generally have a molecular weight greater than 3000, specifically greater than 4000, and more specifically greater than 6000. These are commercially available from S.C. Johnson Polymer, LLC (now owned by BASF) under the trade name JONCRYL®, ADR 4368 material. Other types of polyfunctional polymer materials with multiple epoxy groups are acrylic and/or polyolefin copolymers and oligomers containing glycidyl groups incorporated as side chains. A further example of such a polyfunctional carboxy-reactive material is a co- or ter-polymer including units of ethylene and glycidyl methacrylate (GMA), available under the trade name LOTADER® resin, sold by Arkema. These materials can further comprise methacrylate units that are not glycidyl. An example of this type is poly(ethylene-glycidyl methacrylate-co-methacrylate).

Fatty acid esters or naturally occurring oils containing epoxy groups (epoxidized) can also be used. Examples of naturally occurring oils are olive oil, linseed oil, soybean oil, palm oil, peanut oil, coconut oil, seaweed oil, cod liver oil, or a mixture of these compounds. Particular preference is given to epoxidized soybean oil (e.g., Merginat ESBO from Hobum, Hamburg, or EDENOL® B 316 from Cognis, Dusseldorf), but others may also be used.

Another type of cross-linking agent are agents with two or more double bonds. Cross-linking agents with two or more double bond cross-link PHAs by after reacting at the double bonds. Examples of these include: diallyl phthalate, pentaerythritol tetraacrylate, trimethylolpropane triacrylate, pentaerythritol triacrylate, dipentaerythritol pentaacrylate, diethylene glycol dimethacrylate, bis(2-methacryloxyethyl)phosphate.

In general, it appears that compounds with terminal epoxides perform better than those with epoxide groups located elsewhere on the molecule.

Compounds having a relatively high number of end groups are the most desirable. Molecular weight may also play a role in this regard, and compounds with higher numbers of end groups relative to their molecular weight (e.g., the JONCRYL®s are in the 3000-4000 g/mol range) are likely to perform better than compounds with fewer end groups relative to their molecular weight (e.g., the Omnova products have molecular weights in the 100,000-800,000 g/mol range).

### Nucleating Agents

If desired, an optional nucleating agent is added to the compositions of the invention to aid in its crystallization. Nucleating agents for various polymers are simple substances, metal compounds including composite oxides, for example, carbon black, calcium carbonate, synthesized silicic acid and salts, silica, zinc white, clay, kaolin, basic magnesium carbonate, mica, talc, quartz powder, diatomite, dolomite powder, titanium oxide, zinc oxide, antimony oxide, barium sulfate, calcium sulfate, alumina, calcium silicate, metal salts of organophosphates, and boron nitride; low-molecular organic compounds having a metal carboxylate group, for example, metal salts of such as octylic acid, toluic acid, heptanoic acid, pelargonic acid, lauric acid, myristic acid, palmitic acid, stearic acid, behenic acid, cerotic acid, montanic acid, melissic acid, benzoic acid, p-tert-butylbenzoic acid, terephthalic acid, terephthalic acid monomethyl ester, isophthalic acid, and isophthalic acid monomethyl ester; high-molecular organic compounds having a metal carboxylate group, for example, metal salts of such as: carboxyl-group-containing polyethylene obtained by oxidation of polyethylene; carboxyl-group-containing polypropylene obtained by oxidation of polypropylene; copolymers of olefins, such as ethylene, propylene and butene-1, with acrylic or methacrylic acid; copolymers of styrene with acrylic or methacrylic acid; copolymers of olefins with maleic anhydride; and copolymers of styrene with maleic anhydride; high-molecular organic compounds, for example: alpha-olefins branched at their 3-position carbon atom and having no fewer than 5 carbon atoms, such as 3,3 dimethylbutene-1,3-methylbutene-1,3-methylpentene-1,3-methylhexene-1, and 3,5,5-trimethylhexene-1; polymers of vinylcycloalkanes such as vinylcyclopentane, vinylcyclohexane, and vinylnorbornane; polyalkylene glycols such as polyethylene glycol and polypropylene glycol; poly(glycolic acid); cellulose; cellulose esters; and cellulose ethers; phosphoric or phosphorous acid and its metal salts, such as diphenyl phosphate, diphenyl phosphite, metal salts of bis(4-tert-butylphenyl) phosphate, and methylene bis-(2,4-tert-butylphenyl)phosphate; sorbitol derivatives such as bis(p-methylbenzylidene) sorbitol and bis(p-ethylbenzylidene) sorbitol; and thioglycolic anhydride, p-toluenesulfonic acid and its metal salts. The above nucleating agents may be used either alone or in combinations with each other. In particular embodiments, the nucleating agent is cyanuric acid. In certain embodiments, the nucleating agent can also be another polymer (e.g., polymeric nucleating agents such as PHB).

In certain embodiments, the nucleating agent is selected from: cyanuric acid, carbon black, mica talc, silica, boron nitride, clay, calcium carbonate, synthesized silicic acid and salts, metal salts of organophosphates, and kaolin. In particular embodiments, the nucleating agent is cyanuric acid. In other embodiments, the nucleating agent is a food grade nucleating agent.

In various embodiments, where the nucleating agent is dispersed in a liquid carrier, the liquid carrier is a plasticizer, e.g., a citric compound or an adipic compound, e.g., acetylcitrate tributyrate (CITROFLEX® A4, Vertellus, Inc., High Point, N.C.), or DBEEA (dibutoxyethoxyethyl adipate), a surfactant, e.g., Triton X-100, TWEEN-20, TWEEN-65, Span-40 or Span 85, a lubricant, a volatile liquid, e.g., chloroform, heptane, or pentane, a organic liquid or water.

In other embodiments, the nucleating agent is aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole.

In particular embodiments, the nucleating agent can include aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole. The nucleant can have a chemical formula selected from the group consisting of

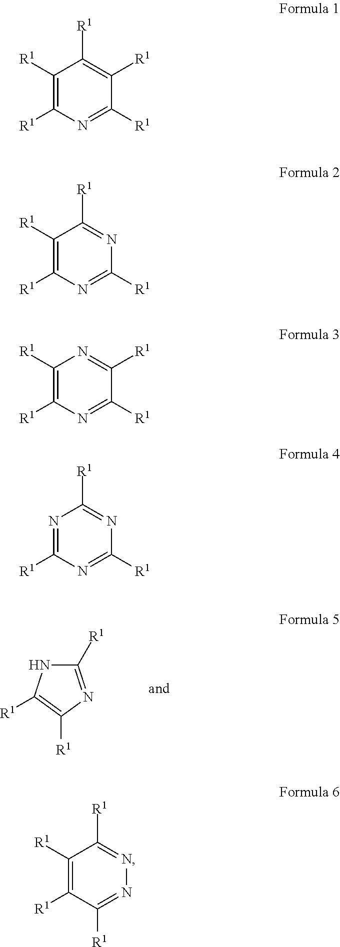

and combinations thereof, wherein each R1 is independently H, NR²R², OR², SR², SOR², SO₂R², CN, COR², CO₂R², CONR²R², NO₂, F, Cl, Br, or I; and each R² is independently H or C₁-C₆ alkyl.

The nucleating agent can be a nucleating agent as described in U.S. Published Application No. US 2005/0209377, by Allen Padwa, which is herein incorporated by reference in its entirety.

Another nucleating agent for use in the compositions and methods described herein are milled as described in International Publication No. WO 2009/129499, published in English on Oct. 22, 2009, and which designates the United States, which is herein incorporated by reference in its entirety. Briefly, the nucleating agent is milled in a liquid carrier until at least 5% of the cumulative solid volume of the nucleating agent exists as particles with a particle size of 5 microns or less. The liquid carrier allows the nucleating agent to be wet milled. In other embodiments, the nucleating agent is milled in liquid carrier until at least 10% of the cumulative solid volume, at least 20% of the cumulative solid volume, at least 30% or at least 40%-50% of the nucleating agent can exist as particles with a particle size of 5 microns or less, 2 microns or less or 1 micron or less. In alternative embodiments, the nucleating agents are milled by other methods, such as jet milling and the like. Additionally, other methods are utilized that reduce the particle size.

The cumulative solid volume of particles is the combined volume of the particles in dry form in the absence of any other substance. The cumulative solid volume of the particles is determined by determining the volume of the particles before dispersing them in a polymer or liquid carrier by, for example, pouring them dry into a graduated cylinder or other suitable device for measuring volume. Alternatively, cumulative solid volume is determined by light scattering.

### Application of the Compositions

The compositions described herein can be processed into films of varying thickness, for example, films of uniform thickness ranging from 1-200 microns, for example, 10-75 microns, 75 to 150 microns, or from 50-100 microns. Film layers can additionally be stacked to form multilayer films of the same or varying thicknesses or compositions of the same or varying compositions. The multilayer compositions can also form laminates of one or more layers of the multilayer compositions. Additionally one or more PHA layers can be added to the multilayer film for controlled degradation or control conditions for the application.

Blow molding, which is similar to thermoforming and is used to produce deep draw products such as bottles and similar products with deep interiors, also benefits from the increased elasticity and melt strength and reduced sag of the polymer compositions described herein.

Articles made from the compositions can be annealed according to any of the methods disclosed in International Publication No. WO 2010/008445, which was published in English on Jan. 21, 2010, and designated the United States, and is titled “Branched PHA Compositions, Methods For Their Production, And Use In Applications,” which was filed in English and designated the United States. This application is incorporated by reference herein in their entirety.

As disclosed herein, “annealing” and “heat treatment” means a treatment where the polymer composition processed to a product in nonliquid form is subsequently (i.e., after the film is formed) heated for a period of time. This has been found to provide surprising and unexpected properties of puncture toughness and tear resistance in the films comprising the compositions of the invention. Preferably the flat film is heated to about 80° C. to about 140° C. for about 5 seconds to about 90 minutes, more preferably to about 90° C. to about 130° C. for about 10 minutes to about 70 minutes, and most preferably to about 110° C. to about 125° C. for about 15 minutes to about 60 minutes.

The compositions described herein are provided in any suitable form convenient for an intended application. For example, the composition is provided in pellet for subsequent production of films, coatings, moldings or other articles, or the films, coatings, moldings and other articles. In certain embodiment, the films of the invention are used for food storage articles and the like.

The specific examples below are to be construed as merely illustrative, and not limitative of the remainder of the disclosure in any way whatsoever. Without further elaboration, it is believed that one skilled in the art can, based on the description herein, utilize the present invention to its fullest extent. All publications cited herein are hereby incorporated by reference in their entirety.

### EXAMPLES

### Experimental Methods

### Materials

The PHA materials used in the examples was a blend of 34-38% P3HB, 22-26% P3HB-4HB copolymer with 8-14% 4HB by weight and 38-42% P3HB-4HB copolymer with 25-33% 4HB by weight. The polyvinyl alcohol resin used as the barrier layer was G-Polymer® supplied by Soarus LLC. It reportedly has high amorphous content but also has crystalline-like functions producing very high barrier properties to oxygen and hydrogen. The polymer is also water soluble, can be melt processed like conventional thermoplastic polymers and is biocompostable. The material for the adhesive layer was Plexar® PX1164 ethylene vinyl acetate copolymer with maleic anhydride grafts (LyondellBasel Industries).

### Example 1

### Preparation of PHA/EVAc-MA/PVOH/EVAc-MA/PHA Films

In this example, several five layer films were prepared and tested for oxygen and water barrier properties. Several different adhesive layers are used and evaluated (EVAc and LLDPE) including blends of PHA/PVOH, PHA/PLA and PHA with EVAc-MA. The best adhesion was found with the PHA/EVAc-MA blend as the adhesive layer.

The PHA material was initially compounded into pellets using a 27 mm MAXX Leistritz twin-screw extruder using the following temperature profile: Ten zones set at 175/175/170/170/170/165/165/165/160/160° C. The extrusion concentration was set at 85 lbs/hr and the extruder was operated at 130 rpm. The melt temperature was in the range 190-199° C. while the melt pressure was in the range of 1744 to 2062 psi.

The PHA formulation contained PHA Blend 73.21% by weight, Acrawax CV concentrate (50% active) 0.4% by weight, talc 0.6% by weight (Optibloc® 10, available from Specialty Minerals Inc., Bethlehem, Pa., USA), Citroflex A4 plasticizer 0.85%, Paraplex® A8600 (Hallstar) at 7% by weight, Trigonox® 101 peroxide (Akzo Nobel) at 0.08% by weight, SR231 crosslinking agent (Sartomer), Filmlink 500 calcium carbonate (Imerys) at 15% by weight and a nucleating masterbatch 4% by weight (composed of 33% cyanuric acid dispersed and milled in Citroflex A4).

Four 1 inch extruders were used to construct the co-extruded film: two extruders produced the PHA compounded film, one extruder for the PVOH film and one for the adhesive layer. The profile temperatures for each o the extruders are shown with Table 1. When the films were combined in the blown film die, a temperature of 335-360° C. was used.

The objective of the experiment was to make multilayer films with the compounded PHA formulation sandwiching the high barrier PVOH (G-Polymer® PVOH) which is moisture sensitive in between the PHA film to produce a high gas barrier film that is not affected or minimally (without detrimental effects) by moisture. Table 1 shows the multilayer film construction while Table 2 shows the moisture and oxygen permeation rates for films #9-12. Included are results for the compounded PHA film alone.

It was found that the interfacial adhesion between PHA film and the G-Polymer was very poor without an adhesive; this meant using non-biodegradable tie layers. The best multilayer film that was produced during this trial used an EVAc-graft-MA copolymer as the tie-layer; this film structure was as follows: [PHA]/[EVA-MA/PHA 60/40 Blend]/[G-Polymer]/[EVA-MA/PHA 60/40 Blend]/[PHA] at the following layer ratio: [36]/[8]/[12]/[8]/[36] microns.

A total of ten different 5-layer films were made during this trial, with a PHA outer film layer and a G-Polymer core in all of the film constructions. G-Polymer had excellent melt strength and its extrusion melt processing was very good. However, it was stiff and had very poor tear resistance and puncture toughness.

The barrier properties for films #9-11 are shown in Table 2. All of these films used adhesive composed of the EVAc-MA/PHA blend. Film #12 however used EVAc-MA/polylactic acid (PLA, NatureWorks) blend in place of the EVAC-MA/PHA blend for the adhesive. Film #12 showed very poor adhesion however for the PHA/PVOH film. The oxygen transmission rates for the multilayer films #9-12 as compared to the compounded PHA film showed lower rates by a factor of at least 600. The moisture transmission rates however increased as compared to the compounded PHA film.

TABLE 1
Summary of Multilayer Films made with PHA (extruders A and
D), PVOH (Extruder C) and various adhesive layers (Extruder B).

| | A | B | C | D | |
|---|---|---|---|---|---|
| | Material | Material | Material | Material | |
| | (Screw | (Screw | (Screw | (Screw | |
| Film # | RPM) | RPM) | RPM) | RPM) | Notes |
| 1 | PHA* (40) | — | G (20) | PHA* (40) | Very poor interfacial adhesion |
| 2 | PHA* (33) | NBX007 (16) | G (16) | PHA* (33) | Poor adhesion . . . slightly better |
| | | | | | than #1 . . . adhesion good with |
| | | | | | “G”, poor with PHA* |
| 3 | PHA* (50) | NBX007 (16) | G (16) | PHA* (50) | Adhesion same as in #2 |
| 4 | PHA* (33) | LLDPE-MA | G (16) | PHA* (33) | Poor adhesion . . . slightly better |
| | | (16) | | | than #1 . . . worse than |
| | | | | | #2 . . . adhesion good with “G”, |
| | | | | | poor with PHA* |
| 5 | PHA* (33) | PHA*/G- | G (16) | PHA* (33) | Poor adhesion . . . poor film |
| | | Polymer 50/50 | | | quality because of poor mixing |
| | | Blend (22) | | | in “B” |
| 6, 7 | PHA* (33) | PHA*/ | G (16) | PHA* (33) | Good adhesion . . . adhesion |
| | | Plexar800 | | | improved at higher die |
| | | 80/20 Blend | | | temperature |
| | | (22) | | | |
| 8 | PHA* (33) | PHA*/ | G (16) | PHA* (33) | Good adhesion . . . same as in #6 |
| | | Plexar800 | | | and #7 |
| | | 65/35 Blend | | | |
| | | (22) | | | |
| 9 | PHA* (33) | PX1164/ | G (16) | PHA* (33) | Very good interfacial |
| | | PHA* 60/40 | | | adhesion . . . best candidate so far |
| | | Blend (22) | | | |
| 10 | PHA* (50) | PX1164/ | G (16) | PHA* (50) | Very good interfacial |
| | | PHA* 60/40 | | | adhesion . . . best candidate so far |
| | | Blend (22) | | | |
| 11 | Same as | | | | |
| | #10 . . . higher drawdown ratio . . . thinner film | | | | |
| 12 | PHA* (34) | PLA/G- | G (16) | PHA* (34) | Poor adhesion |
| | | Polymer 50/50 | | | |
| | | Blend (16) | | | |

The co-ex equipment uses four 1-inch extruders with a 5-layer blown film feedblock and a 2-inch die. The residence time (contact time between the various layers) is very short (1-2 seconds) in this feedblock; the interfacial adhesion is expected to be better with larger co-ex dies.
Four 1-inch extruders . . . A, B, C, D
Film layer construction . . . A/B/C/B/D
PHA extrusion temperature profile . . . 350/340/335/330 (° F.)
G-Polymer (“G”) extrusion temperature profile . . . 375/375/380/380 (° F.)
Blown film die temperature setting . . . 335-360° F.
NBX007 is an EVA-based adhesive resin with proprietary tackifiers blended-in . . . this apparently bonds well with PLA. It is processed using the following profile: 360/370/380/380 (° F.).
Plexar800 is a LLDPE-based adhesive resin with very high levels of MA grafted into the polymer. Processed using a flat 360° F. temperature profile.
PX1164 is an EVA-graft-MA based adhesive tie-layer resin processed using a 375° F. flat temperature profile.

TABLE 2
Summary of water vapor transmission rates and oxygen
permeation rates (at 0% relative humidity) for films #9-12 from Table 1.

| | WVTR @ 100% | |
|---|---|---|
| | RH | OTR @ 0% RH |
| Film ID | (g · mil/m2 · day) | (cc · mil/m2 · day) |
| PHA* | 125 | 2175 |
| #9 | 340 | 10.6 |
| #10 | 554 | 3.6 |
| #11 | 860 | 3.8 |
| #12 | 713 | 5.3 |

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A multilayer composition comprising:
a) a first outer layer comprising a polyhydroxyalkanoate polymer blend,
b) a first adhesive layer adjacent to the first outer layer,
c) a core layer comprising polyvinyl alcohol adjacent to the first adhesive layer,
d) a second adhesive layer adjacent to the core; and
e) a second outer layer adjacent to the second adhesive layer comprising a polyhydroxyalkanoate polymer blend.

2. The multilayer composition of claim 1, wherein at least one outer layers comprises a polyhydroxyalkanoate polymer blend of 34-38% by weight poly-3-hydroxybutyrate (P3HB), 22-26% by weight copolymer of 3-hydroxybutyrate (3HB) and 4-hydroxybutyrate (4HB) with a weight % 4HB of 8-14% and 38-42% by weight copolymer of 3-hydroxybutyrate (3HB) and 4-hydroxybutyrate (4HB) with a weight % of 4HB 25-33%.

3. The multilayer composition of claim 2, wherein the polyhydroxyalkanoate polymer blend is branched.

4. The multilayer composition of claim 1, wherein at least one outer layers comprises a branched polyhydroxyalkanoate polymer blend, wherein the branched polyhydroxyalkanoate polymer blend comprises polyhydroxyalkanoate reactively blended with a peroxide and optionally a co-agent.

5. The multilayer composition of claim 1, wherein the composition further includes one or more additives in at least one layer.

6. The multilayer composition of claim 5, wherein the additives are selected from plasticizers, clarifiers, nucleating agents, thermal stabilizers, inorganic fillers, anti-slip agents and antiblocking agents.

7. The multilayer composition of claim 1, wherein at least one adhesive layer comprises polyhydroxyalkanoate.

8. The multilayer composition of claim 1, wherein the core comprises polyvinyl alcohol resin.

9. The multilayer composition of claim 1, wherein at least one adhesive layer comprises comprising a maleic anhydride grafted resin.

10. The multilayer composition of claim 9, wherein the maleic anhydride grafted resin comprises ethylene vinyl acetate copolymer grafted with maleic anhydride.

11. The multilayer composition of claim 1, wherein the composition is free of metal oxide.

12. The multilayer composition of claim 1, wherein the composition is at least 80% biodegradable.

13. The multilayer composition of claim 1, wherein the composition is 100% biodegradable.

14. The multilayer composition of claim 1, wherein the composition has high oxygen barrier properties.

15. A laminate comprising at least one layer of the multilayer composition of claim 1.

16. A method of making the composition of claim 1, comprising
coextruding two outer layers, a core, an adhesive layer, into a multilayer film feedblock, and
combining the extruded layers together, wherein the adhesive layer is separated into two layers.
